(19) United States
(12) Patent Application Publication
(10) Pub. No.: US 2018/0314218 A1
(43) Pub. Date: Nov. 1, 2018

(54) METHOD FOR AUTOMATICALLY MAKING A DECISION

(71) Applicant: F&P ROBOTICS AG, Glattbrugg (CH)

(72) Inventors: Lucas EICHER, Wallisellen (CH); Christoph MÜRI, Zürich (CH); Hans Rudolf FRÜH, Aadorf (CH)

(21) Appl. No.: 15/769,767

(22) PCT Filed: Nov. 4, 2016
(86) PCT No.: PCT/EP2016/076754

§ 371 Date: Apr. 20, 2018

Related U.S. Application Data
(60) Provisional application No. 62/251,756, filed on Nov. 6, 2015.

(51) Int. Cl. G05B 19/042; G05B 13/02

(52) U.S. Cl. CPC G05B 19/042; G05B 2219/25255; G05B 13/029

(57) ABSTRACT

A method for the automatic decision-making for execution of actions in a situational context. The method includes detecting a measured value with a sensor, deriving a first function on the basis of the measured values with an artificial neural network, calculating a second function from the first function and a temporally preceding value of the second function by the first algorithm, deciding on execution of the action by the second algorithm on the basis of a third function, executing the action when the third function delivers the value 1, and resetting the second function when the third function delivers the value 1.

### CROSS-REFERENCE TO RELATED APPLICATION

This application is a U.S. National Stage application of International Application No. PCT/EP2016/076754, filed Nov. 4, 2016, which claims priority to U.S. Application No. 62/251,756, filed Nov. 6, 2015, the contents of each of which are hereby incorporated herein by reference.

### BACKGROUND

### Field of the Invention

The invention relates to a method for the automatic decision-making about the execution of actions in a situational context. The invention further relates to a program-controlled machine for performing a method. The method can be used in an autonomous system, such as e.g. a robot, which has one or several actions, in order to decide which of the actions are to be executed by the robot at a given time. The method is suitable for decisions on the execution of actions, whose execution requirements do not only depend on current measured values, but also on their temporal course.

### Background Information

Conventional automatic decision-making machine are known in the art.

### SUMMARY

It is assumed, that the situational context is defined by at least one measured variable M, which can be detected by at least one sensor. In this case, the sensor delivers measured variable-specific measured values M(tₖ), which are available in the course of time at defined times t₀, . . . ,tₘ.

A first function V₁(tₐ) or a reward value can be derived on the basis of the measured values M(tₖ) (k=a−1, . . . , a−m) up to the time ta via an artificial neural network at a current time tₐ. The function V₁(tₐ) reflects the current need for the execution of the action at time tₐ.

Furthermore, a second function V₂(tₐ) or a basic reward value can be assigned to the action at a time tₐ, which is calculated by a first algorithm from the first function V₁(tₐ) and the temporally preceding value of V₂(tₐ₋₁). The function V₂(tₐ) reflects the cumulative need for the execution of the action at time tₐ.

The two functions V₁(tₐ) and V₂(tₐ) can also be created and improved by manually guiding the program-controlled machines or a part of the program-controlled machine, in particular a teach-tool. As a result, an automatic sequence generation and continuous improvement of the system can be achieved.

The decision on the execution of the action at time tₐ is made via a second algorithm realizing a third function F(tₐ,M(tₐ),V₁(tₐ),P₁,P₂)->{0,1}, which compares, at the time tₐ, the measured value with a first parameter P₁ at the time tₐ and the value of the second function V₂(tₐ) with a second parameter P₂. In this case, P₁ is an action and measured variable-specific parameter or limit measured value representing an upper or a lower threshold value depending on the measured variable and P₂ is an action specific parameter or a limit reward value.

The essential advantage of the method according to the invention is therefore that the decision on the execution of an action is not derived solely from the comparison of a current measured value with a limit measured value, which must be exceeded or fallen below, so that it comes to a decision for the execution of the action, but also from a cumulative basic reward value, which is aggregated from current reward values. The current reward value can also have a negative value, so that the cumulative basic reward value can not only increase but also decrease in the temporal course. The decision on the execution of an action is made even if the cumulative basic reward value increases a limit reward value.

In addition, values that are generated by manually guiding the program-controlled machine or a part of the program-controlled machine, in particular a teach-tool, can also be used for the calculation of the functions V₁(tₐ) and V₂(tₐ). As a result, an automatic sequence generation and a continuous improvement of the system can be achieved, i.e. the sequence generation can be made capable of learning by manual intervention (feedback loops), so that e.g. failures of the past can be avoided in the future.

The method according to the invention is used for the automatic decision-making of a program-controlled machine about the execution of at least one action A in a situational context. The program-controlled machine comprises,
at least one sensor for detecting at least one measured variable M, which sensor delivers the measured values M(tₖ) (k=0, . . . ,m) of the measured variable M at defined times t₀, . . . ,tₘ;
at least one artificial neural network (ANN) deriving a first function V₁(tₐ) at a current time tₐ on the basis of the measured values M(tₖ) (k=a, a−1, . . . , a−m);
a first algorithm (Algo1) calculating a second function V₂(tₐ) from the first function V₁(tₐ) and the temporally preceding value of V₂(tₐ₋₁) at the time tₐ;
a second algorithm (Algo2) realizing a third function F(tₐ,M(tₐ),V₂(tₐ),P₁,P₂)->{0,1}, which compares, at the time tₐ, the measured value M(tₐ) with a first parameter P₁ at the time tₐ and the second function V₂ with a second parameter P₂;
   the method comprising the following steps at any time tₐ (a>0):
detecting the measured value M(tₐ) by the sensor, deriving the first function V₁(tₐ) on the basis of the measured values M(tₖ) (k=a, a−1, . . . , a−m) by the artificial neural network (ANN),
calculation of the second function V₂(tₐ) from the first function V₁(tₐ) and the temporally preceding value of the second function V₂(tₐ₋₁) by the first algorithm (Algo1),
decision on the execution of action A by the second algorithm (Algo2) on the basis of the third function F,
execution of action A when the third function F delivers the value 1,
resetting the second function V₂(tₐ) when the third function F delivers the value 1.

In an advantageous embodiment of the invention, the first algorithm (Algo1) calculates the value of the second function V₂(tₐ) at the time tₐ as the sum of the value of the first function V₁(tₐ) at the time tₐ and the value of V₂(tₐ₋₁) at the preceding time tₐ₋₁: V₂(tₐ):=V₁(tₐ)+V₂(tₐ₋₁). Of course, it is also possible that the first algorithm (Algo1) calculates the value of the second function V₂(tₐ) at the time ta as the product or difference of the value of the first function V₁(tₐ) at the time tₐ and the value of V₂(tₐ₋₁) at the preceding time tₐ₋₁.

It is also possible, that the first parameter P₁ and/or the second parameter P₂ is time-dependent and/or dependent on another variable, in particular the location.

In a particularly advantageous embodiment, a plurality of measured variables M is detected by a plurality of sensors, wherein the execution of a single action A is decided. It is also possible, that a single measured variable M is detected by one sensor or a plurality of sensors and the execution of several actions A is decided. Of course it is also possible, that a plurality of measured variables M is detected by a plurality of sensors and the execution of a plurality of actions A is decided.

Advantageously, the parameter P₁ represents an upper threshold value or a lower threshold value.

Finally, the program-controlled machine, by which the method according to the invention is performed, is a permanently installed machine or a mobile machine, in particular a robot.

The invention also relates to a program-controlled machine for performing a method, wherein the program-controlled machine comprises:
at least one sensor for detecting at least one measured variable M, which sensor delivers the measured values M(tₖ) (k=0, . . . ,m) of the measured variable M at defined times t₀, . . . ,tₘ;
at least one artificial neural network (ANN) deriving a first function V₁(tₐ) at a current time tₐ on the basis of the measured values M(tₖ) (k=a, a−1, . . . , a−m);
a first algorithm (Algo1) calculating a second function V₂(tₐ) from the first function V₁(tₐ) and the temporally preceding value of V₂(tₐ₋₁) at the time tₐ;
a second algorithm (Algo2) realizing a third function F(tₐ,M(tₐ),V₂(tₐ),P₁,P₂)->{0,1}, which compares, at the time tₐ, the measured value M(tₐ) with a first parameter P₁ at the time tₐ and the second function V₂(tₐ) with a second parameter P₂ and executing the action A at the time tₐ, when the third function F delivers the value 1.

### DESCRIPTION OF THE DRAWINGS

The invention will be explained in more detail hereinafter with reference to the drawings.

FIG. 1 is a schematic illustrating the process used to decide on the execution of a single action.

### DETAILED DESCRIPTION OF THE EMBODIMENTS

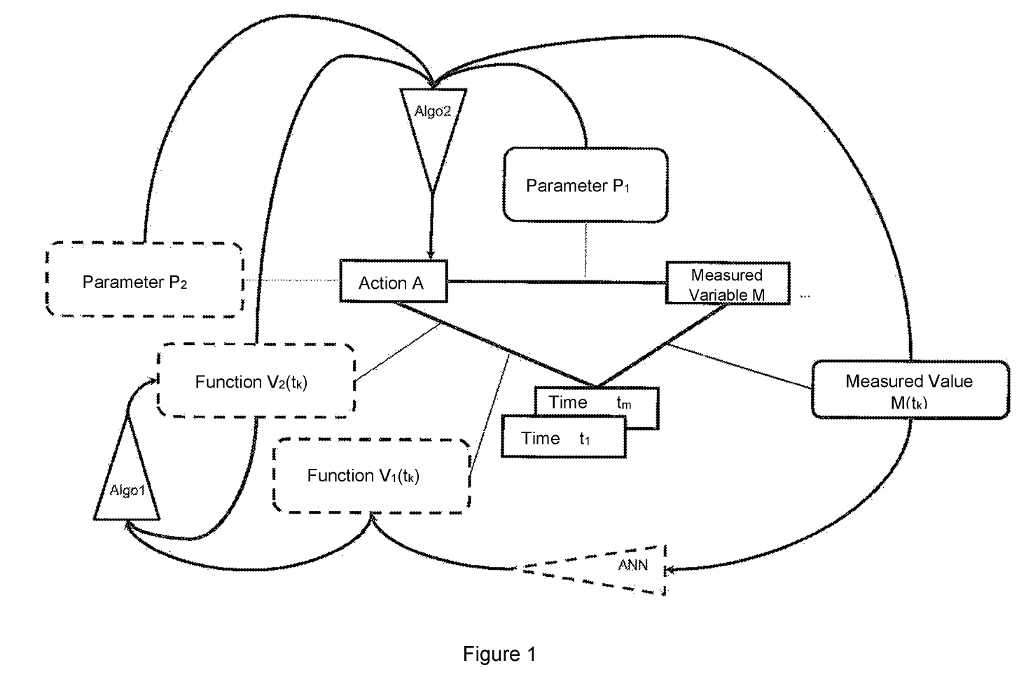

The method according to the invention is now described in more detail with reference to an embodiment and the diagram according to FIG. 1.

In the embodiment, the method is used to decide on the execution of a single action A on the basis of a single measured variable M. Of course, the method according to the invention can also be used for the decision-making about the execution of a single action A or several actions A on the basis of a single measured variable M and/or several measured variables M.

The method according to the invention could be used for example in an automatic irrigation system for a garden, which represents a program-controlled machine in the sense of the invention. The possible action A could be the irrigation of the garden via a sprinkler system. A possible measured variable M would be the amount of precipitation over the past 100 hours. This measured variable M could be detected by a sensor, which delivers the corresponding measured values M(tₖ) at defined times t₀, . . . ,tₘ.

A first parameter P₁ or a limit measured value would have to be defined for the action A irrigation of the garden and the measured variable M. A second parameter P₂ or a limit reward value would also have to be defined for action A. An appropriately trained artificial neural network (ANN) would derive a first function V₁(tₐ) or a reward value from the measured values M(tₖ) of the sensor at any time tₐ. V₁(tₐ) would be positive at times of low or no precipitation in the past 100 hours, conversely, V₁(tₐ) would be negative with significant precipitation. The reward value represented by the first function V₁(tₐ) would therefore reflect the current need of the action A at the time tₐ.

From the reward values of the past, the first algorithm (Algo1) could calculate a second function V₂(tₐ) or a basic reward value at the time tₐ from the value of the first function V₁(tₐ) at the time tₐ and the temporally preceding value of V₂(tₐ₋₁). The basic reward value represented by the second function V₂(tₐ) would therefore reflect the cumulative need of the action A at the time tₐ.

The second algorithm (Algo2) would decide irrigation at the time tₐ, if the measured value of the amount of precipitation falls below the first parameter P₁ (limit measured value) specific to irrigation at the time tₐ, or if the second function V₂(tₐ) (basic reward value) specific to irrigation increases the defined second parameter P₂ (limit reward value). This decision would be realized by a third function F(tₐ,M(tₐ),V₂(tₐ),P₁,P₂)->{0,1}, wherein the action A is executed and the second function V₂(tₐ) is reset, when the third function F delivers the value 1.

Furthermore, the first algorithm (Algo1) could be modified such that it calculates the value of the second function V₂(tₐ) at the time tₐ as the sum of the value of the first function V₁(tₐ) at the time tₐ and the value of V₂(tₐ₋₁) at the preceding time tₐ₋₁: V₂(tₐ):=V₁(tₐ)+V₂(tₐ₋₁). An initial value is assigned to the second function V₂(t₀).

A further modification of the method could be that the first parameter P₁ and/or the second parameter P₂ are each time-dependent.

An extended embodiment relates to an irrigation system of a garden, which has several actions, irrigation via a sprinkler system, irrigation via a drip system. In addition to the amount of precipitation of the past 100 hours, the air temperature, the air pressure and the air humidity could be used as further measured variables, for which measured values are delivered via corresponding sensors at defined times.

1. A method for the automatic decision-making of a program-controlled machine about the execution of at least one action in a situational context, the program-controlled machine comprising,
at least one sensor configured to detect, at least one measured variable M, the sensor delivering measured values of the measured variable at defined times;
at least one artificial neural network configured to derive a first function (V1(ta)) at a current time (ta) on the basis of the measured values;
a first algorithm configured to calculate a second function (V2(ta)) from the first function and a temporally preceding value of (ta−1) at the current time;
a second algorithm configured to realize a third function (F(ta,M(ta),V2(ta),P1,P2)->{0,1}, which compares, at the current time, the measured value with a first parameter at the current time and the second function with a second parameter;
the method comprising, at any time ta (a>0):
detecting the measured value with the sensor;
deriving the first function on the basis of the measured values with the artificial neural network;
calculating the second function from the first function and the temporally preceding value of the second function by the first algorithm;
deciding on execution of the action by the second algorithm on the basis of the third function;
executing the action when the third function delivers the value 1; and
resetting the second function when the third function delivers the value 1.

2. The method according to claim 1, wherein the first algorithm calculates the value of the second function at the current time as the sum of the value of the first function at the current time and the temporally preceding value of at a preceding time (ta−1):
V2(ta):=V1(ta)+V2(ta−1)

3. The method according to claim 1, wherein the first parameter is time-dependent.

4. The method according to claim 1, wherein the second parameter is time-dependent.

5. The method according to claim 1, wherein a plurality of measured variables is detected by a plurality of sensors and wherein the execution of a single action is decided.

6. The method according to claim 1, wherein the at least sensor detects a single measured variable and wherein the execution of several actions is decided.

7. The method according to claim 1, wherein a plurality of measured variables is detected by a plurality of sensors and wherein the execution of a plurality of actions is decided.

8. The method according to claim 1, wherein the parameter represents an upper threshold value.

9. The method according to claim 1, wherein the parameter represents a lower threshold value.

10. The method according to claim 1, wherein the program-controlled machine is a permanently installed machine or a mobile machine.

11. A program-controlled machine for performing a method according to claim 1, the program-controlled machine comprising:
the at least one sensor configured to detect the at least one measured variable, the sensor configured to deliver the measured values of the measured variable at the defined times;
the at least one artificial neural network configured to derive the first function at the current time on the basis of the measured values;
the first algorithm configured to calculate the second function from the first function and a temporally preceding value at the current time;
the second algorithm configured to realize the third function, which compares, at the current time, the measured value with the first parameter at the current time and the second function with the second parameter and executing the action at the current time, when the third function delivers the value 1.

12. The program-controlled machine according to claim 11, wherein the first algorithm is configured to calculate the value of the second function at the current time as the sum of the value of the first function at the current time and the temporally preceding value of the preceding time: V2(ta):=V1(ta)+V2(ta−1).

13. The program-controlled machine according to claim 11, wherein the program-controlled machine is a permanently installed machine or a mobile machine.

14. The method according to claim 1, wherein the program-controlled machine is a robot.

15. The program-controlled machine according to claim 11, wherein the program-controlled machine is a robot.
